(19) United States
(12) Patent Application Publication
(10) Pub. No.: US 2024/0342823 A1
(43) Pub. Date: Oct. 17, 2024

(54) WIRE-FEEDING ELECTROMAGNETIC SPRAY ADDITIVE MANUFACTURING DEVICE AND METHOD

(71) Applicant: Nanchang Hangkong University, Nanchang (CN)

(72) Inventors: Timing ZHANG, Nanchang (CN); Jilin XIE, Nanchang (CN); Jinyang HU, Nanchang (CN); Jianliang LIU, Nanchang (CN); Shanlin WANG, Nanchang (CN); Yuhua CHEN, Nanchang (CN); Yang SHEN, Nanchang (CN); Shiyi ZHANG, Nanchang (CN); Guanpeng LIU, Nanchang (CN); Mingwei WEI, Nanchang (CN)

(21) Appl. No.: 18/638,056

(22) Filed: Apr. 17, 2024

Related U.S. Application Data
(63) Continuation of application No. PCT/CN2023/136947, filed on Dec. 7, 2023.

(30) Foreign Application Priority Data
Apr. 12, 2023 (CN) 202310384530.X

(51) Int. Cl. B23K 20/12; B23K 20/06; B23K 20/14; B33Y 10/00; B33Y 30/00

(52) U.S. Cl. CPC B23K 20/1215; B23K 20/06; B23K 20/14; B33Y 10/00; B33Y 30/00

(57) ABSTRACT

A wire-feeding electromagnetic spray additive manufacturing device and method are provided. The device includes a housing, an alternating current power box is fixedly installed on the housing, and a stirring needle is also arranged in the housing. The device further includes a fixed seat fixedly installed in the housing, and a heating coil is arranged between the fixed seat and the stirring needle; a lower end of the stirring needle is provided with spinnerets and heating channels adapted with corresponding the spinnerets respectively; upper ends of the heating channels penetrate through the stirring needle and are fixedly connected with the housing, and an extrusion assembly is fixedly installed on each of the heating channels; and a smoke pipe is fixedly installed on the extrusion assembly, and an upper end of the smoke pipe penetrates through the housing and is connected with a negative pressure fan.

### CROSS-REFERENCE TO RELATED APPLICATIONS

This application is a continuation of PCT/CN2023/136947, filed on Dec. 7, 2023 and claims priority of Chinese Patent Application No. 202310384530.X, filed on Apr. 12, 2023, the entire contents of which are incorporated herein by reference.

### TECHNICAL FIELD

The disclosure relates to the technical field of surface engineering, and particularly to a wire-feeding electromagnetic spray additive manufacturing device and method.

### BACKGROUND

Surface spraying is a technology to strengthen and protect a surface of a workpiece. At present, commonly used surface spraying processing technologies are mainly divided into a thermal spraying technology and a cold spraying technology. The thermal spraying technology is a processing method that uses gas, liquid fuel or arc, plasma arc and laser as heat sources to heat spraying materials such as metals, alloys, metal cermets, oxides, carbides, plastics and their composite materials to a molten or semi-molten state, atomize the spraying materials by high-speed airflow, and then spray and deposit the atomized spraying materials on a pretreated working surface, thereby forming a firmly attached surface layer.

When an arc is used as a heat source, two sprayed metal wires are used as consumable electrodes, and the two continuously fed metal wires are respectively connected with a positive pole and a negative pole of direct current (DC). When ends of the metal wires are short-circuited, the ends of the two metal wires are simultaneously melted and sprayed on a surface of a substrate under an action of high-speed airflow to form a coating.

Because of a high temperature of arc spraying, there must be metal evaporation during the spraying. The evaporated metal stays in air for a long time, forming metal dust, which is easy to be inhaled into lungs. Workers who have been engaged in the spraying for a long time may suffer from occupational diseases such as pneumoconiosis and metal fever.

### SUMMARY

An objective of the disclosure is to solve following problems in the prior art. Due to a high temperature of arc spraying, there may be metal evaporation during the spraying. The evaporated metal stays in air for a long time, forming metal dust, which is easy to be inhaled into lungs. Workers who have been engaged in the spraying for a long time may suffer from occupational diseases such as pneumoconiosis and metal fever. Therefore, the disclosure provides a wire-feeding electromagnetic spray additive manufacturing device and method.

In order to achieve the above objective, the disclosure adopts a following technical scheme.

A wire-feeding electromagnetic spray additive manufacturing device, including a housing, where an alternating current (AC) power box is fixedly installed on the housing, and a stirring needle is arranged in the housing. The device further includes: a fixed seat fixedly installed in the housing, where a heating coil is arranged between the fixed seat and the stirring needle, and an input end of the heating coil is connected with the AC power box through a wire. A lower end of the stirring needle is provided with spinnerets and heating channels, each of the heating channel is adapted with corresponding one of the spinnerets. Upper ends of the heating channels penetrate through the stirring needle and are fixedly connected with the housing, and an extrusion assembly is fixedly installed on each of the heating channels. A smoke pipe is fixedly installed on each of the extrusion assembly, and an upper end of the smoke pipe penetrates through the housing and is connected with a negative pressure fan.

In order to protect the stirring needle and improve stability of wire feeding, in an embodiment, the device further includes a protective sleeve rotatably installed in the housing, where a lower end of the protective sleeve penetrates through the housing and is slidably installed with a flying plate, and a sealed bearing is fixedly installed between the protective sleeve and the stirring needle.

In order to stir and rub a surface of a substrate to produce severe plastic deformation, and further crush a wire on the substrate into a dense coating, in an embodiment, a ring gear is fixedly installed on the protective sleeve, a motor is fixedly installed in the housing, and a cone-shaped gear meshed and connected with the ring gear is fixedly installed at an output end of the motor.

In order to improve an extrusion speed of the wire after melting, in an embodiment, the each of the extrusion assembly includes: a melting chamber fixedly installed on corresponding one of the heating channels, where two meshed extrusion gears are rotatably installed in the melting chamber, and a driving gear coaxial with corresponding one of the extrusion gears is rotatably installed on an outer wall of the melting chamber; and a horizontal plate rotatably installed in the stirring needle, where two symmetrically arranged driving rods are rotatably installed above the horizontal plate; an upper end of each of the driving rods penetrates through the stirring needle and is fixedly installed with a magnetic block on surfaces opposite to the protective sleeve, two magnetic blocks are opposite in magnetism; and an arc rack meshed with the driving gear is fixedly installed below the horizontal plate.

In order to restrict sliding directions of the driving rods, in an embodiment, slide rail seats are fixedly installed in the stirring needle, and each of the driving rods is slidably installed in corresponding one of the slide rail seats.

In order to improve efficiency of a smoke absorption, in an embodiment, a gas permeable membrane is fixedly installed in the melting chamber, and a smoke collection cavity is formed between the gas permeable membrane and a top inside the melting chamber.

In order to slidably connect the flying plate, the device further includes multiple metal rods slidably installed in the housing, where an electromagnetic pulse coil is sleeved on each of the metal rods, and lower ends of the metal rods penetrate through the housing and are jointly installed with a driving plate; one side, close to the flying plate, of the driving plate is provided with a chute and connecting rods sliding in the chute in a matching manner, and lower ends of the connecting rods are fixedly connected with the flying plate.

In order to control the electromagnetic pulse coils to power on or off the metal rods simultaneously, in an embodiment, a limit seat is fixedly installed in the housing, and limit sleeves are equidistantly and circumferentially installed on the limit seat, and a metal wire connected between adjacent electromagnetic pulse coils is fixed in corresponding one of the limit sleeves.

In order to control a high-speed movement of the flying plate, in an embodiment, an upper surface of the fixed seat is provided with a groove extending inward; multiple push rods are elastically connected in the groove, and a push plate in contact with a top end of each of the push rods is fixedly installed below the ring gear.

A wire-feeding electromagnetic spray additive manufacturing method, including following steps:

S1, sending the wire from a wire feeder to the stirring needle and heating the wire into a molten state;

S2, enabling the flying plate which carries molten materials to impact a substrate at a high speed to form metallurgical bonding; and

S3, driving the protective sleeve to rotate through the motor to cause the flying plate to perform stirring, friction, and rolling motions.

Compared with the prior art, the disclosure provides a wire-feeding electromagnetic spray additive manufacturing device and method, which have following beneficial effects.

Firstly, according to the wire-feeding electromagnetic spray additive manufacturing device, two metal wires fed continuously enter the heating channels in the stirring needle, respectively. The heating coil heats the heating channels, so that the metal wires in the heating channels are gradually heated to become molten substances. The molten substances enter the melting chamber, and smoke generated when one of the metal wires is melted enters and merges the smoke collection cavity after penetrating the gas permeable membrane. A negative ion generator is fixedly installed in the smoke collection cavity, and a DC negative high voltage is formed after a current passes through the negative ion generator, and then a large number of free electrons are emitted from an emitting head to absorb large suspended substances in the smoke, and finally fall. Purified air is discharged through the smoke pipe.

Secondly, according to the wire-feeding electromagnetic spray additive manufacturing device, during rotation of the protective sleeve, magnetic blocks on the protective sleeve sequentially attracts the two driving rods to rise, and the rising driving rods drive the horizontal plate at the same side to rotate. At this time, the arc rack on the horizontal plate drives the meshed driving gear to rotate, and the rotating driving gear rotates the two meshed extrusion gears in the melting chamber. When the extrusion gears are from engaging to disengaging, a local vacuum is formed in a suction cavity, and the molten substances are sucked, and the sucked molten substances are filled in all the tooth valleys of the extrusion gears and brought to the discharge cavity. When the extrusion gears are meshed, the molten substances are pressurized, discharged from each of the spinnerets, and sprayed onto the substrate. At this time, the rotating protective sleeve drives the slidably connected flying plate to stir and rub the surface of the substrate to produce severe plastic deformation, so that the wire on the substrate is crushed into the dense coating.

Thirdly, according to the wire-feeding electromagnetic spray additive manufacturing device, during a rotation period of the ring gear, the push plates on a lower surface of the ring gear push the push rods to slide down, and the sliding push rods push the metal rods to move down to leave centers of the electromagnetic pulse coils. When the push plates release pressures on the push rods, the metal rods will be sucked back into the electromagnetic pulse coils, a reciprocating motion is formed, so that the flying plate continuously impacts the molten substances on the substrate at a high speed, metallurgical bonding is formed between the molten substances and the surface of the substrate.

### BRIEF DESCRIPTION OF THE DRAWINGS

FIG. 1 is a schematic structural diagram of a wire-feeding electromagnetic spray additive manufacturing device according to the disclosure.

FIG. 2 is a schematic structural diagram from a second perspective of the wire-feeding electromagnetic spray additive manufacturing device according to the disclosure.

FIG. 3 is a schematic diagram of an internal structure of a stirring needle of the wire-feeding electromagnetic spray additive manufacturing device according to the disclosure.

FIG. 4 is a schematic diagram of a partial structure of an extrusion assembly of the wire-feeding electromagnetic spray additive manufacturing device according to the disclosure.

FIG. 5 is a schematic structural diagram of part A in FIG. 1 of the wire-feeding electromagnetic spray additive manufacturing device according to the disclosure.

FIG. 6 is a schematic structural diagram of part B in FIG. 2 of the wire-feeding electromagnetic spray additive manufacturing device according to the disclosure.

FIG. 7 is a schematic structural diagram of part C in FIG. 3 of the wire-feeding electromagnetic spray additive manufacturing device according to the disclosure.

FIG. 8 is a flowchart of a wire-feeding electromagnetic spray additive manufacturing method according to the disclosure.

### DETAILED DESCRIPTION OF THE EMBODIMENTS

In the following, technical schemes in embodiments of the disclosure may be clearly and completely described with reference to attached drawings in embodiments of the disclosure. Apparently, the described embodiments are only a part of the embodiments of the disclosure, but not all of the embodiments.

In a description of the disclosure, it should be understood that azimuth or positional relationships indicated by terms “upper”, “lower”, “front”, “rear”, “left”, “right”, “top”, “inner” and “outer” are based on the azimuth or positional relationships shown in the attached drawings, and are only for the convenience of describing the disclosure and simplifying the description, and do not indicate or imply that a referred device or an element must have a specific azimuth, be constructed and operated in a specific azimuth. Therefore, the terms may not be understood as a limitation of the disclosure.

### Embodiment 1:

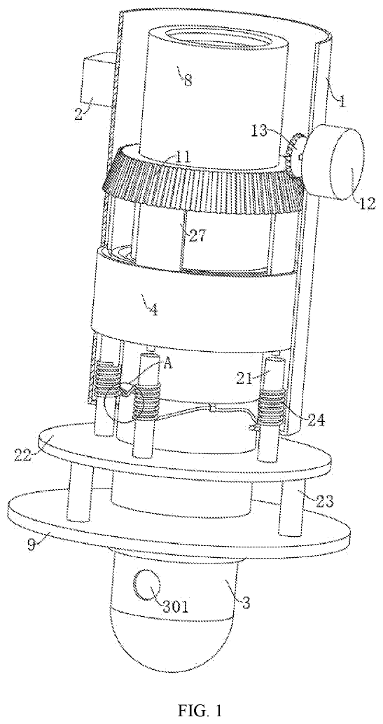

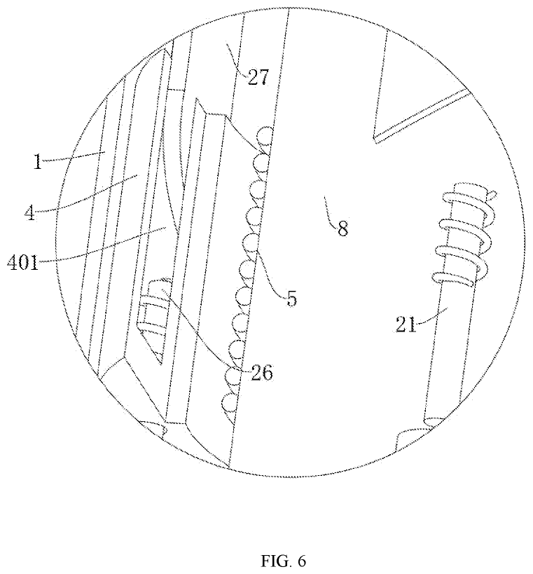

With reference to FIGS. 1 to 7, a wire-feeding electromagnetic spray additive manufacturing device includes a housing 1, an AC power box 2 is fixedly installed on the housing 1, and a stirring needle 3 is also arranged in the housing 1. The device further includes a fixed seat 4 fixedly installed in the housing 1, a heating coil 5 is arranged between the fixed seat 4 and the stirring needle 3, and an input end of the heating coil 5 is connected with the AC power box 2 through a wire. A lower end of the stirring needle 3 is provided with spinnerets 301 and heating channels 6 adapted to the corresponding spinnerets 301. The heating channels 6 are spiral and made of aluminum alloy materials with good thermal conductivity to accelerate melting of metal wires. Upper ends of the heating channels 6 penetrate through the stirring needle 3 and are fixedly connected with the housing 1, and an extrusion assembly is fixedly installed on each of the heating channels 6; a smoke pipe 7 is fixedly installed on the extrusion assembly, and an upper end of the smoke pipe 7 penetrates through the housing 1 and is connected with a negative pressure fan.

When an arc is used as a heat source, two metal wires fed continuously are connected with a positive pole and a negative pole of DC respectively. At the moment of short-circuit at ends of the metal wires, the ends of the two metal wires are simultaneously melted and sprayed on a surface of a substrate under an action of a high-speed airflow to form a coating.

In this embodiment, the two metal wires fed continuously enter the heating channels 6 in the stirring needle 3, respectively. When a high-frequency alternating current in the AC power box 2 passes through the heating coil 5, an alternating magnetic field around the heating coil 5 is generated. The heating channels 6 in the stirring needle 3 are used as a heated conductor, and the magnetic field passes through the heating channels 6 in the heating coil 5 to generate an induced current to form an eddy current. When the eddy current flows on surfaces of the heating channels 6, the heating channels 6 is lead to heat up, and when the metal wires pass through the spiral heating channels 6, a heating time of the metal wires is increased, and then the metal wires enter the extrusion assemblies in a molten state and are ejected from the spinnerets 301.

High-temperature steam generated by heating the metal wires is discharged through the smoke pipe 7 under an action of the negative pressure fan. Metal steam is discharged into air after dust removal and filtration, an air pollution quality is reduced.

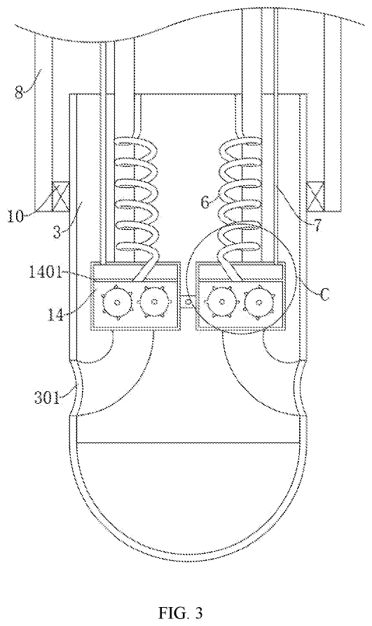

With reference to FIGS. 1, and 3, the device further includes a protective sleeve 8 rotatably installed in the housing 1, a lower end of the protective sleeve 8 penetrates through the housing 1 and is slidably installed with a flying plate 9, and a sealed bearing 10 is fixedly installed between the protective sleeve 8 and the stirring needle 3.

In the housing 1, the stirring needle 3 is coaxially installed in the protective sleeve 8, and the protective sleeve 8 may rotate along an axis of the housing 1 relative to the stirring needle 3. The rotating protective sleeve 8 may drive the slidably connected flying plate 9 to stir and rub the surface of the substrate to generate severe plastic deformation, further a wire on the substrate is crushed into a dense coating.

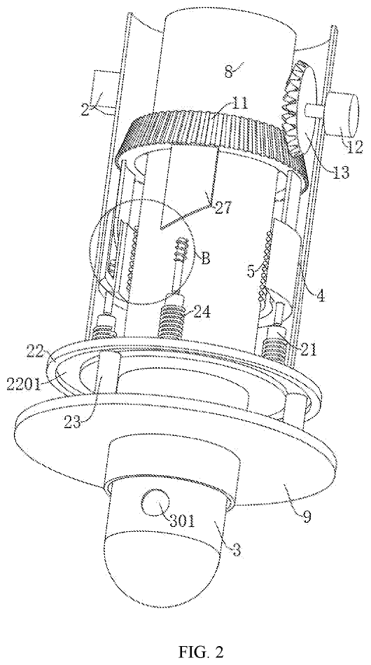

With reference to FIGS. 1 and 2, in an embodiment, a ring gear 11 is fixedly installed on the protective sleeve 8, a motor 12 is fixedly installed in the housing 1, and a cone-shaped gear 13 meshed and connected with the ring gear 11 is fixedly installed at an output end of the motor 12.

During an operation of the motor 12, the output end of the motor 12 drives the cone-shaped gear 13 to rotate, and the rotating cone-shaped gear 13 drive the meshed ring gear 11 to rotate to provide a power for rotation of the protective sleeve 8.

With reference to FIGS. 3, 4 and 7, flow speeds of molten metal wires are slow, and the molten metal wires are easy to accumulate in the heating channels 6, so the extrusion assemblies in this scheme are further optimized.

Each of the extrusion assemblies includes: a melting chamber 14 fixedly installed on each of the heating channels 6, two meshed extrusion gears 15 are rotatably installed in the melting chamber 14, and a driving gear 16 coaxial with corresponding one of the extrusion gears 15 is rotatably installed on an outer wall of the melting chamber 14; and a horizontal plate 17 rotatably installed in the stirring needle 3, where two symmetrically arranged driving rods 18 are rotatably installed above the horizontal plate 17. Upper ends of the driving rods 18 penetrate through the stirring needle 3 and are fixedly installed with magnetic blocks 19 with opposite magnetism on surfaces opposite to the protective sleeve 8. An arc rack 20 meshed with the driving gear 16 is fixedly installed below the horizontal plate 17.

During the rotation of the protective sleeve 8, when magnetic blocks 19 on the protective sleeve 8 rotate above one of the driving rods 18, mutually attractive magnetic blocks 19 will pull the one of the driving rods 18 to rise, and the rising one of the driving rods 18 will drive the horizontal plate 17 on the same side to rotate. At this time, the arc rack 20 on the horizontal plate 17 drives the meshed driving gear 16 to rotate, and the rotating driving gear 16 rotates the two meshed extrusion gears 15 in the melting chamber 14. Due to a continuous operation of the extrusion gears 15, the melting chamber 14 is divided into two independent parts, namely, a suction cavity and a discharge cavity. When the extrusion gears 15 are from engaging and disengaging, a local vacuum is formed in the suction cavity, and molten substances are sucked, and sucked molten substances are filled in all tooth valleys of the extrusion gears 15 and brought to the discharge cavity. When the extrusion gears 15 are meshed, the molten substances are pressurized and discharged from each of the spinnerets 301.

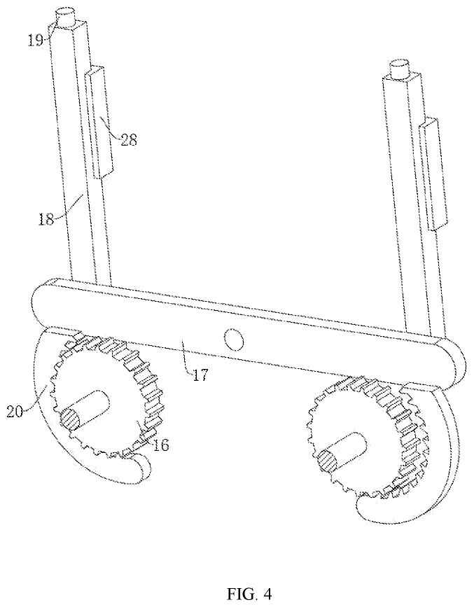

With reference to FIG. 4, in an embodiment, slide rail seats 28 are fixedly installed in the stirring needle 3, and the driving rods 18 are slidably installed in the slide rail seats 28.

When the magnetic blocks 19 on the protective sleeve 8 pull the driving rods 18, the slide rail seats 28 restrict sliding directions of the driving rods 18, the arc rack 20 from derailing the driving gear 16 is effectively prevented.

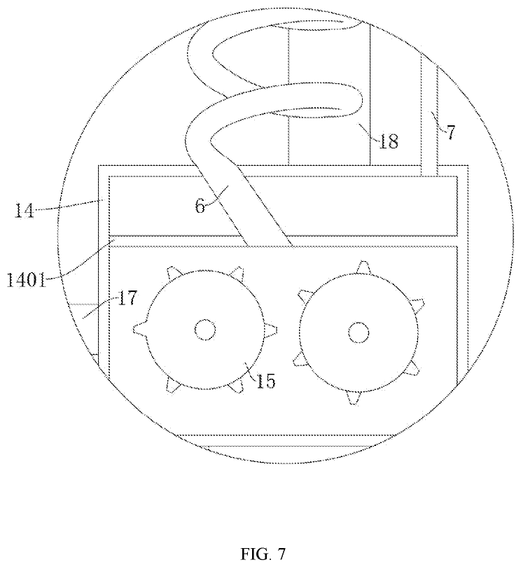

With reference to FIGS. 3 and 7, in an embodiment, a gas permeable membrane 1401 is fixedly installed in the melting chamber 14, and a smoke collection cavity is formed between the gas permeable membrane 1401 and a top inside the melting chamber 14.

Smoke generated when one of the metal wires is melted enters and merges the smoke collection cavity through the gas permeable membrane 1401, and the negative ion generator is fixedly installed in the smoke collection cavity. A DC negative high voltage is formed after a current passes through the negative ion generator, and then a large number of free electrons are emitted from an emitting head to absorb large suspended substances in the smoke, and finally fall. Purified air is discharged through the smoke pipe 7.

Generally speaking, in this embodiment, the two metal wires fed continuously enter the heating channels 6 in the stirring needle 3, respectively. The heating coil 5 heats the heating channels 6, so that the metal wires in the heating channels 6 are gradually heated to become molten substances. The molten substances enter the melting chamber 14, and the smoke generated when the one of the metal wires is melted enters and merges the smoke collection cavity after penetrating the gas permeable membrane 1401. The negative ion generator is fixedly installed in the smoke collection cavity, and the DC negative high voltage is formed after the current passes through the negative ion generator, and then the large number of free electrons are emitted from the emitting head to absorb the large suspended substances in the smoke, and finally fall. The purified air is discharged through the smoke pipe 7.

During the operation of the motor 12: the magnetic blocks 19 on the protective sleeve 8 sequentially attracts the two driving rods 18 to rise, and the rising driving rods 18 drive the horizontal plate 17 at the same side to rotate. At this time, the arc rack 20 on the horizontal plate 17 drives the meshed driving gear 16 to rotate, and the rotating driving gear 16 rotates the two meshed extrusion gears 15 in the melting chamber 14. Due to the continuous operation of the extrusion gears 15, the melting chamber 14 is divided into two independent parts, namely, the suction cavity and the discharge cavity. When the extrusion gears 15 are from being engaged to being disengaged, the local vacuum is formed in the suction cavity, and the molten substances are sucked, and the sucked molten substances are filled in all the tooth valleys of the extrusion gears 15 and brought to the discharge cavity. When the extrusion gears 15 are meshed, the molten substances are pressurized, discharged from each of the spinnerets 301, and sprayed onto the substrate. At this time, the rotating protective sleeve 8 drives the slidably connected flying plate 9 to stir and rub the surface of the substrate to generate severe plastic deformation, further the wire on the substrate is crushed into the dense coating.

### Embodiment 2:

With reference to FIGS. 1 to. 7, the Embodiment 2 is basically the same as Embodiment 1. On a basis of Embodiment 1, a whole technical scheme is further optimized.

There are pores in the coating heated by the arc, so corrosion resistance of the coating is deteriorated, and a bonding strength of the coating is reduced, mechanical properties of the coating is deteriorated. With reference to FIGS. 1, 2 and 6, the wire-feeding electromagnetic spray additive manufacturing device in this embodiment further includes a plurality of metal rods 21 slidably installed in the housing 1, and the number of the metal rods 21 is four and the metal rods 21 are arranged in a ring shape. Electromagnetic pulse coils 24 are sleeved on the metal rods 21, and lower ends of the metal rods 21 penetrate through the housing 1 and are jointly provided with a driving plate 22. One side, close to the flying plate 9, of the driving plate 22 is provided with a chute 2201 and connecting rods 23 sliding in the chute 2201 in a matching way, and lower ends of the connecting rods 23 are fixedly connected with the flying plate 9.

Because densities of magnetic lines in centers of the electromagnetic pulse coils 24 are the largest, the centers of the electromagnetic pulse coils 24 are positions with strongest magnetic forces. When the electromagnetic pulse coils 24 are energized, the metal rods 21 located inside will oscillate back and forth in the electromagnetic pulse coils 24 for several cycles and then be sucked at the centers of the electromagnetic pulse coils 24. Therefore, during an oscillation period and a process of the metal rods 21 being sucked into the electromagnetic pulse coils 24, the driving plate 22 drives the flying plate 9 to rapidly impact the molten substances on the substrate, so that the molten substances form metallurgical bonding with an upper surface of the substrate.

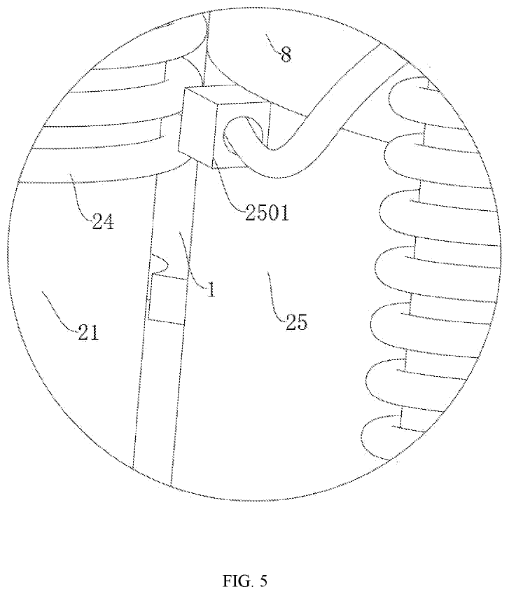

With reference to FIG. 5, in an embodiment, a limit seat 25 is fixedly installed in the housing 1, and limit sleeves 2501 are equidistantly and circumferentially installed on the limit seat 25, and metal wires connected between adjacent electromagnetic pulse coils 24 are fixed in the limit sleeves 2501.

Adjacent electromagnetic pulse coils 24 are connected in series with each other. When energized, magnetic fields are simultaneously generated on the electromagnetic pulse coils 24 and act on the metal rods 21.

With reference to FIGS. 1, 2 and 6, in an embodiment, an upper surface of the fixed seat 4 is provided with a groove 401 extending inward. A plurality of push rods 26 are elastically connected in the groove 401, and the number of the push rods 26 is the same as the number of the metal rods 21, and the push rods 26 are located on same axes with the metal rods 21. Push plates 27 in contact with top ends of the push rods 26 are fixedly installed below the ring gear 11.

Because the electromagnetic pulse coils 24 are always energized, the metal rods 21 will not change after being sucked into the electromagnetic pulse coils 24. During a rotation period of the ring gear 11, the push plates 27 on a lower surface of the ring gear 11 push the push rods 26 to slide down, and the downward sliding push rods 26 push the metal rods 21 to move down to leave the centers of the electromagnetic pulse coils 24. When the push plates 27 release pressures on the push rods 26, the metal rods 21 will be sucked back into the electromagnetic pulse coils 24 to form a reciprocating action, so that the flying plate 9 will continuously impact the substrate at a high speed.

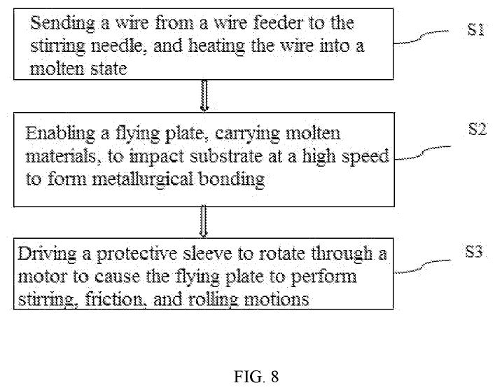

As shown in FIG. 8, a wire-feeding electromagnetic spray additive manufacturing method includes following steps.

S1, the two metal wires fed continuously enter the heating channels 6 in the stirring needle 3, respectively. When the high-frequency alternating current in the AC power box 2 passes through the heating coil 5, the alternating magnetic field around the heating coil 5 is generated. The heating channels 6 in the stirring needle 3 are used as a heated conductor, and the magnetic field passes through the heating channels 6 in the heating coil 5 to generate the induced current to form the eddy current. When the eddy current flows on the surfaces of the heating channels 6, the heating channels 6 is caused to be heated up, and when the metal wires pass through the spiral heating channels 6, the heating time of the metal wires is increased, and then the metal wires enter the extrusion assemblies in the molten state and are ejected from the spinnerets 301.

S2, the molten substances enter into the melting chamber 14, and the smoke generated when the one of the metal wires is melted enters and merges the smoke collection cavity through the gas permeable membrane 1401. The negative ion generator is fixedly installed in the smoke collection cavity, and the DC negative high voltage is formed after the current passes through the negative ion generator, and then the large number of free electrons are emitted from the emitting head to absorb the large suspended substances in the smoke, and finally fall. The purified air is discharged through the smoke pipe 7.

S3, when the electromagnetic pulse coils 24 are energized, the metal rods 21 located inside will oscillate back and forth in the electromagnetic pulse coils 24 for several cycles and then be sucked at the centers of the electromagnetic pulse coils 24. Therefore, during the oscillation period and the process of the metal rods 21 being sucked into the electromagnetic pulse coils 24, the driving plate 22 drives the flying plate 9 to rapidly impact the molten substances on the substrate, the metallurgical bonding is formed between the molten substances and the upper surface of the substrate.

S4, while the driving plate 22 drives the flying plate 9 to impact back and forth, the flying plate 9 rotates under the action of the motor 12 to stir and rub the surface of the substrate to generate severe plastic deformation, further the wire on the substrate is crushed into the dense coating.

The above is only the preferred embodiments of the disclosure, but a protection scope of the disclosure is not limited to this. Any person familiar with the technical field who makes equivalent replacement or change according to the technical scheme and an inventive concept of the disclosure within the technical scope disclosed by the disclosure should be included in the protection scope of the disclosure.

What is claimed is:

1. A wire-feeding electromagnetic spray additive manufacturing device, comprising a housing, wherein an alternating current power box is fixedly installed on the housing, and a stirring needle is arranged in the housing; the device further comprises:
a fixed seat fixedly installed in the housing, wherein a heating coil is arranged between the fixed seat and the stirring needle, and an input end of the heating coil is connected with the alternating current power box through a wire;
a lower end of the stirring needle is provided with spinnerets and heating channels, each of the heating channels is adapted with corresponding one of the spinnerets; upper ends of the heating channels penetrate through the stirring needle and are fixedly connected with the housing, and an extrusion assembly is fixedly installed on each of the heating channels; and
a smoke pipe is fixedly installed on the extrusion assembly, and an upper end of the smoke pipe penetrates through the housing and is connected with a negative pressure fan.

2. The wire-feeding electromagnetic spray additive manufacturing device according to claim 1, further comprising a protective sleeve rotatably installed in the housing, wherein a lower end of the protective sleeve penetrates through the housing and is slidably installed with a flying plate, and a sealed bearing is fixedly installed between the protective sleeve and the stirring needle.

3. The wire-feeding electromagnetic spray additive manufacturing device according to claim 2, wherein a ring gear is fixedly installed on the protective sleeve, a motor is fixedly installed in the housing, and a cone-shaped gear meshed and connected with the ring gear is fixedly installed at an output end of the motor.

4. The wire-feeding electromagnetic spray additive manufacturing device according to claim 3, wherein the extrusion assembly comprises:
a melting chamber fixedly installed on corresponding one of the heating channels, wherein two meshed extrusion gears are rotatably installed in the melting chamber, and a driving gear coaxial with corresponding one of the extrusion gears is rotatably installed on an outer wall of the melting chamber; and
a horizontal plate rotatably installed in the stirring needle, wherein two symmetrically arranged driving rods are rotatably installed above the horizontal plate; an upper end of each of the driving rods penetrates through the stirring needle and is fixedly installed with a magnetic block on a surface opposite to the protective sleeve, two magnetic blocks are opposite in magnetism; and an arc rack meshed with the driving gear is fixedly installed below the horizontal plate.

5. The wire-feeding electromagnetic spray additive manufacturing device according to claim 4, wherein slide rail seats are fixedly installed in the stirring needle, and each of the driving rods is slidably installed in corresponding one of the slide rail seats.

6. The wire-feeding electromagnetic spray additive manufacturing device according to claim 5, wherein a gas permeable membrane is fixedly installed in the melting chamber, and a smoke collection cavity is formed between the gas permeable membrane and a top inside the melting chamber.

7. The wire-feeding electromagnetic spray additive manufacturing device according to claim 3, further comprising:
a plurality of metal rods slidably installed in the housing, wherein an electromagnetic pulse coil is sleeved on each of the metal rods, and lower ends of the metal rods penetrate through the housing and are jointly installed with a driving plate; one side, close to the flying plate, of the driving plate is provided with a chute and connecting rods sliding in the chute in a matching manner, and lower ends of the connecting rods are fixedly connected with the flying plate.

8. The wire-feeding electromagnetic spray additive manufacturing device according to claim 7, wherein a limit seat is fixedly installed in the housing, and limit sleeves are equidistantly and circumferentially installed on the limit seat, and a metal wire connected between adjacent electromagnetic pulse coils is fixed in corresponding one of the limit sleeves.

9. The wire-feeding electromagnetic spray additive manufacturing device according to claim 3, wherein an upper surface of the fixed seat is provided with a groove extending inward; a plurality of push rods are elastically connected in the groove, and a push plate in contact with a top end of each of the push rods is fixedly installed below the ring gear.

10. A wire-feeding electromagnetic spray additive manufacturing method, using the wire-feeding electromagnetic spray additive manufacturing device according to claim 1, wherein the method comprises following operation steps:
S1, sending a wire from a wire feeder to the stirring needle, and heating the wire into a molten state;
S2, enabling a flying plate, carrying molten materials, to impact substrate at a high speed to form metallurgical bonding; and
S3, driving a protective sleeve to rotate through a motor to cause the flying plate to perform stirring, friction, and rolling motions.
